(19) United States
(12) Patent Application Publication
(10) Pub. No.: US 2023/0008014 A1
(43) Pub. Date: Jan. 12, 2023

(54) DATA PROCESSING DEVICE, DATA-PROCESSING METHOD AND RECORDING MEDIA

(71) Applicant: RENESAS ELECTRONICS CORPORATION, Tokyo (JP)

(72) Inventors: Shunsuke OKUMURA, Tokyo (JP); Koichi NOSE, Tokyo (JP)

(21) Appl. No.: 17/369,686

(22) Filed: Jul. 7, 2021

(51) Int. Cl. G06N 20/00; G06N 5/04

(52) U.S. Cl. CPC G06N 20/00; G06N 5/04

(57) ABSTRACT

The data processing device includes the inference processor and learning processor. The inference processor includes a input data determination circuit for determining whether or not each of the binarized input data is a predetermined value, a memory for storing a plurality of coefficient and a coefficient address information including information about a coefficient address in which a plurality of coefficient are stored, an inference controller for reading coefficient address from the storage unit based on a determination result of the input data determination circuit and reading coefficient from the storage unit based on coefficient address, a arithmetic circuit for performing an operation using the binarized input data and coefficient acquired by the inference controller to generate the arithmetic operation result as a output data.

### BACKGROUND

The present disclosure relates to a data processing device having a learning function at an endpoint.

Endpoint devices implementing inference programs are used in a variety of environments, such as in-plant lines and outdoors. However, the recognition accuracy may be deteriorated in an environment that is not included in the learning data in advance, such as a change in lighting conditions or a background.

However, it is impractical from a resources standpoint to perform a learning process at the endpoint using algorithms such as error back-propagation. Therefore, an endpoint device equipped with the latest learned AI model (e.g., neural network) learned in the cloud is used. However, because the amount of data in the learned AI model is very large, a large amount of memory, a processor with nigh processing capacity, and the like are required. When implementing the learned AI model on an endpoint device, it is necessary to compress the learned AI model.

There are disclosed techniques listed below. [Patent Document 1] U.S. Patent Application Publication No. 2021/0132866

For example, Patent. Document 1 discloses an inference processing using coefficient address information and coefficient.

### SUMMARY

It is desired that the end point device equipped with the learned AI model suppresses the deterioration of the recognition accuracy under all circumstances. Other objects and novel features will become apparent from the description of this specification and the accompanying drawings.

The data processing device of an embodiment comprises an inference processor and a learning processor. The inference processor comprising an input data determination circuit determined to determine whether or not it is a predetermined value for each of binarized input data, a memory storing a plurality of coefficients and a coefficient address information including information about the coefficient address in which the plurality of coefficient, an inference controller reading the coefficient address from the memory on the basis of a determination result of the input data determination circuit and reading the coefficient from the memory on the basis of the coefficient address, and an arithmetic circuit that performs an operation using the binarized input data and the coefficient acquired by the inference controller to generate the arithmetic operation result as an output data. The learning processor comprising an output distribution calculate circuit analyzing the output data and calculating a correction value of the coefficient based on the analysis result, a coefficient updating circuit updating the coefficient stored in the memory with the correction value of the coefficient calculated by the output distribution calculate circuit, and a learning processor for controlling the updating of the coefficient.

### BRIEF DESCRIPTION OF THE DRAWINGS

FIG. 1 is a block diagram showing an exemplary configuration of a data processing device according to a first embodiment of present invention.

FIG. 2 is a diagram illustrating an exemplary quantize of a floating point input data into a binarized input data,

FIG. 3 is a diagram. illustrating an exemplary neural network used by the data processing device in an inference processing.

FIG. 4 is a diagram showing the conceptual of a product-sum operation required in the neural network in the data processing device according to the first embodiment.

FIG. 5 is a diagram showing the conceptual of the product-sum operation required in the neural network in the data processing device according to the first embodiment.

FIG. 6 is a diagram showing the conceptual of the product-sum operation required in the neural network in the data processing device according to the first embodiment.

FIG. 7 is a diagram :bowing the conceptual of the product-sum operation required in the neural network in the data processing device according to the first embodiment.

FIG. 8 is a diagram illustrating an exemplary product-sum operation process performed by the data processing device according to the first embodiment.

FIG. 9 is a diagram illustrating an outline of a process flow according to the first embodiment.

FIG. 10 is a flow chart illustrating a detailed process flow according to the first embodiment.

FIG. 11 is a flowchart illustrating a detailed process flow according to the first embodiment.

FIG. 12 is a diagram illustrating an outline of a process flow according to a third embodiment of the present invention.

FIG. 13 is a flowchart illustrating a detailed process flow according to the third embodiment.

FIG. 14 is a diagram illustrating a process flow according to a fourth embodiment of the present invention.

FIG. 15 is a diagram illustrating a process flow according to a fifth embodiment of the present invention.

### DETAILED DESCRIPTION

### First Embodiment

Hereinafter, embodiments of the present invention are described in detail with reference to the drawings. For clarity of explanation, omits and simplifying are appropriately made in the following description and drawings. In addition, the elements described in the drawings as functional blocks for performing various processes can be configured as CPU (Central Processing Unit), memories, and other circuits in terms of hardware, and are realized by programs loaded into the memories in terms of software. Therefore, it is understood by those skilled in the art that these functional blocks can be realized in various forms by hardware alone, software alone, or a combination thereof, and the present invention is not limited to any of them, In the drawings, the same elements are denoted by the same reference numerals, and a repetitive description thereof is omitted as necessary.

The program described above may also be stored on a variety of types of non-temporary computer readable media (recording media) and supplied to a computer. Non-transitory computer readable media includes various types of tangible storage media. Examples of non-transitory computer-readable media include magnetic recording media (e.g., flexible disks, magnetic tapes, hard disk drives), magneto-optical recording media (e.g., magneto-optical disks), CD-ROM (Read Only Memory), a CD-R, a CD-R/W, solid-state memories (e.g., masked ROM, a PROM (Programmable ROM) , an EPROM (Erasable PROM) , a flash ROM, a RAM (Random Access Memory)). The program may also be supplied to the computer by various types of transitory computer-readable media, Examples of transitory computer-readable media include electrical signals, optical signals, and electromagnetic waves. The transitory computer readable medium may provide the program to the computer via wired or wireless communication paths, such as electrical wires and optical fibers.

### <Configuration of Data Processing Unit>

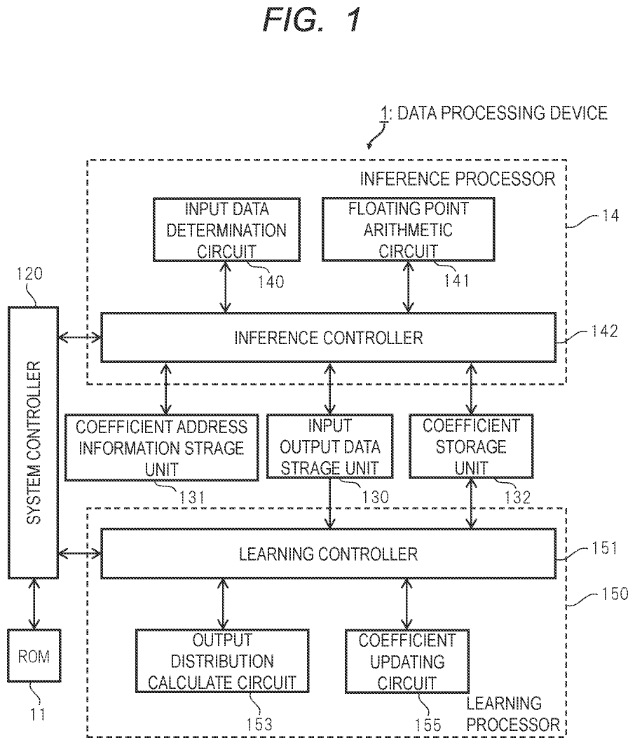

FIG. 1 is a block diagram showing an exemplary configuration of the data processing device according to a first embodiment of a present invention. As shown in FIG. 1, the data processing device 1 includes a system controller 120, an inference controller 142, a learning controller 151, an input output data storage unit 130, a coefficient address information storage unit 131, a coefficient storage unit 132, a floating point arithmetic circuit (Floating Point Unit, FPU) 141, an output distribution calculate circuit 153, a coefficient updating circuit 155, a processor 10, a ROM 11, a RAM 13, and the like.

The inference controller 142, an input data determination circuit. 140, and the floating point arithmetic circuit 141 constitute an inference processor 14.

The learning controller 151, the output. distribution calculate circuit 153, and the coefficient updating circuit 155 constitute a learning processor 150. The learning processor 150 is a functional block for performing learning based on the input data and updating the neural network, which is an AI-model,

Of these configurations element, the system controller 120, the inference controller 142, the learning controller 151, the floating point arithmetic circuit 141, the output distribution calculate circuit 153, and the coefficient updating circuit 155 are implemented in software by the processor 10 executing programs read from a ROM or the like. In addition, some functions may be implemented in hardware, and in this case, each function block may be implemented in cooperation between the software and the hardware.

On the other hand, the input output data storage unit 130, the coefficient address information storage unit 131, the coefficient storage unit 132, and the coefficient updating circuit 155 are provided on the memory such as, for example, the RAM or the ROM. A plurality of the memory may be provided.

These components element constituting the data processing device 1 may be directly connected to each other as shown in FIG. 1, or may be connected to each other via buses (not shown). The data processing device 1 may be configured, for example, as a semiconductor device.

The processor is a processing circuit that executes a program (instruction stream) read from a ROM 11 or the like and performs arithmetic processing. The processor 10 is, for example, a CPU (Central Processing Unit) or a DSP (Digital Signal Processor).

The ROM 11 is the memory that stores a program to be executed by the processor 10. For example, the ROM 11 stores, for example, a program relating to a deep neural network obtained by performing machine-learning of deep learning, a program for realizing the inference controller 142, and the like. In FIG. 1, the ROM 11 is embedded in the data processing device 1, but the data processing device 1 may read the program from the memory provided outside the data processing device 1 and execute the process. The memory that stores the program may be both the data processing device 1 built-in ROM 11 and an external to the data processing device 1.

The memory such as the RAM 13 stores data for the processor 10, the inference processor 14, and the learning processor 150 to perform arithmetic operations. The RAM 13 stores the program read from the ROM 11 and outputs the retained program to the processor 10 in accordance with a request from the processor 10.

The inference processor 14 stores temporary data and the like required for the operation of the neural network in the memory. The learning processor 150 stores temporary data and the like required for the operation of learning the neural network in the memory.

The inference processor 14 is a functional block for performing the inference processing using the neural network. The neural network used in the inference processing is, for example, a deep neural network (DNN), but is not limited thereto. For example, CNN (Convolutional Neural Network) or RNN (Recurrent Neural Network) may be used as the neural network.

Although FIG. 1 shows a configuration example comprising the inference processor 14, the configuration of the data processing device 1 is not limited thereto. The data processing device 1 may be configured to implement the inference processor 14 as software and store the programs in the ROM 11. In addition to the ROM 11 and the memory already described the inference processor 14 may include the memory such as the ROMs or the RAMs in the inference processor 14.

The input output data storage unit 130 is the memory that stores the binarized input data for reasoning in the neural networks. The data input to the neural network is, for example, floating point data. The floating-point data inputted to the inference processor 14 is quantized. into 1-bit digital values by a quantization unit (not shown) and stored in the input output data storage unit 130 as the binarized input data. In other words, the floating-point input data entered into the neural network is quantized to values of either “0” or “1” and stored in the input output data storage unit 130.

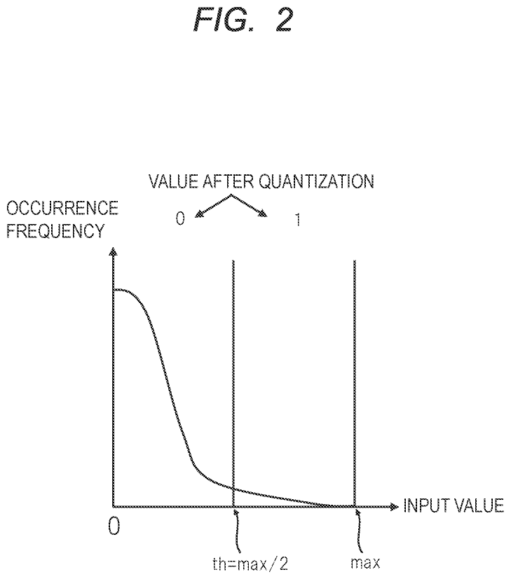

FIG. 2 is a diagram illustrating an exemplary quantize of a floating point input data into the binarized input data. The vertical axis is the input value. The horizontal axis is a occurrence frequency. The threshold is denoted by “th” In the examples shown in FIG. 2, input values are distributed from 0 to max. In the examples shown in FIG. 2, values greater than or equal to 0 and less than th=max/2 are quantized to 0, and values greater than or equal to th=max/2 and less than or equal to max are quantized to 1. In the example of quantization shown in FIG. 2, the threshold value for binarization is set to th=max/2, but quantize method is not limited to the binarized input data. For example, the input data can be quantized to binary data with the thresholds th=max/4. When the threshold value is set to th=max/4, a value of 0 or more and less than th=max/4 is quantized to 0, and a value of th=max/4 or more and max or less is quantized to 1.

Returning to the description of FIG. 1. The coefficient address information storage unit 131 is the memory that stores information about a coefficient address (hereinafter referred to as “coefficient address information”) that indicates the address at which a coefficient of the neural network is stored. Here, the coefficient address is an address value of the coefficient stored in the coefficient storage unit 132. If the coefficient address consists of K bits (K is a natural number), it can identify up to 2^{K} distinct the coefficients. in other words, the inference processor 14 can use up to 2^{K} distinct coefficients as the coefficient of the neural network.

The coefficient address information, on the other hand, includes one or more coefficient address and also includes information about the order in which one or more coefficient address are used (order of operation). In other words, the coefficient address information includes information includes one or more coefficient address information corresponding to multiplying each of the one or more input data and each of the one or more weight parameters (or weight data) in the product-sum operation for the neural network. Thus, the coefficient address information contains the input data to which coefficient(s) is/are multiplied. The coefficient address information can be represented, for example, as a sequence of one or more coefficient address. Specific examples of the coefficient address and the coefficient address information are described in detail below.

The coefficient storage unit 132 is the memory for storing the coefficients of the neural network. The coefficients of the neural network stored in the coefficient storage unit 132 is read out to the learning processor 150. The read coefficient of the neural network is updated by the learning process in the learning processor 150. The coefficients of the neural network stored in the coefficient storage unit 132 is overwritten with the values updated in the learning processor 150 and updated.

The input data determination circuit 140 determines whether or not the binarized input data is a predetermined value. More specifically, the input data determination circuit 140 determines, for example, whether the binarized input data is 1, which is a predetermined value.

The floating point arithmetic circuit 141 is an arithmetic unit that performs an arithmetic operation on a floating point. As will be described later, the floating point arithmetic circuit 141 executes the product-sum operation between the input data and the coefficients by cumulative addition to the coefficients read from the coefficient storage unit 132.

The inference controller 142 is a control circuit for controlling transmission and reception of the binarized input data, the coefficient address, and the coefficients among the input output data storage unit 130, the coefficient address information storage unit 131, the coefficient storage unit 132, the input data determination circuit 140, and the floating point arithmetic circuit 141. More specifically, the inference controller 142 reads the binarized input data from input data storage unit and transmits the read input data to the input data determination circuit 140.

The inference controller 142 reads the coefficient address from the coefficient address information storage unit 131 based on a determination result that the input data is 1 by the input data determination circuit 140. Further, the inference controller 142 reads the coefficient from the coefficient storage unit 132 based on the read coefficient address, and transmits it to the floating point arithmetic circuit 141.

The inference controller 142 reads all input data, performs the cumulative addition, and then stores the result of the cumulative addition in the floating point arithmetic circuit 141 in the memory as the product. sum arithmetic operation result.

The learning controller 151 controls the learning process. The learning controller 151 reads data for example, the product. sum arithmetic operation result) held in the input output data storage unit 130, and transmits the read data to the output distribution calculate circuit 153. The learning controller 151 receives a correction value of the coefficient calculated in the output distribution calculate circuit 153 and transmits the correction value of the received coefficient to the coefficient updating circuit 155. The learning controller 151 transmits the coefficient read from the coefficient storage unit 132 to the coefficient updating circuit 155, and receives the coefficient updated by the coefficient updating circuit 155. The learning controller 151 overwrites the updated coefficient to the coefficient storage unit 132 and updates the coefficient stored by the coefficient storage unit 132.

The output distribution calculate circuit 153 analyzes the product sum arithmetic operation result, which is an output data of the neural network, and calculates the correction value of the coefficient based on an analysis result (e.g., average, variance, deviation, etc.).

The coefficient updating circuit 155 transmits the updated coefficient to the learning controller 151.

### <Inference Processing Method>

Next, the inference processing will be described in detail. In the data processing device 1 according to first embodiment, prior to the inference processing using the neural network in the endpoint device, the learning process using the learned data is performed, and the optimum weight parameter is calculated. In the data processing device 1, typical L coefficients (L is a natural number) is selected from the distributions of the weight parameters obtained by the learning process. The selected L coefficients are stored in the coefficient storage unit 132. Where the L coefficients are floating-point numbers.

In the data processing device 1 relating to first. embodiment, the coefficient address information relating to the coefficient address of L pieces of coefficients is stored in the coefficient address information storage unit 131. For example, the coefficient address is the address relative to the base address of the coefficient storage unit 132. By making the coefficient address a relative address, L coefficient addresses can be represented in fewer bits.

In the data processing device 1, K typical values are preselected from the distributions of the learned weight parameters and stored in the coefficient storage unit 132. As described above, in the data processing device 1 according to first embodiment, the weight parameter, which is floating-point data, is expressed using combinations of the coefficient stored in the coefficient storage unit 132 and the coefficient address information. stored in the coefficient address information storage unit 131,.

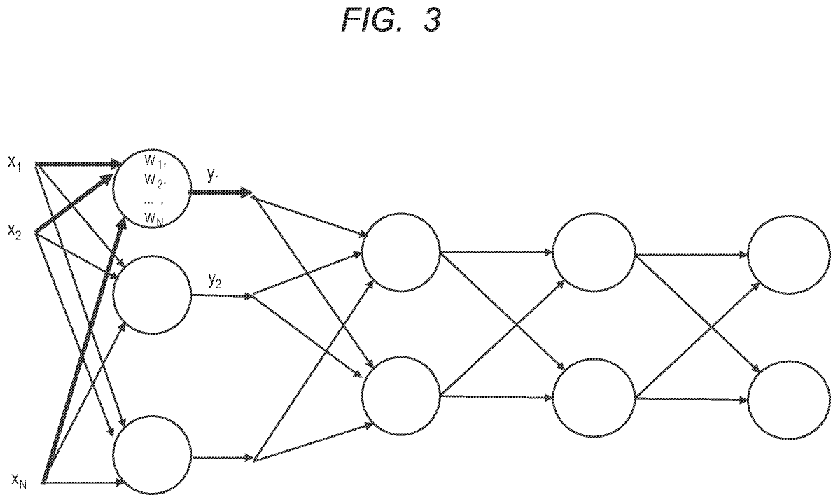

FIG. 3 is a diagram illustrating an exemplary neural network used by the data processing device in the inference processing; The neural network shown in FIG. 3 represents the inference processing processed by the inference processor 14. As shown in FIG. 3, the output data y₁ is calculated by multiplying the input data xᵢ by the weight parameter wᵢ and calculating the sum of the products. Specifically, the sum total of the products is calculated using the following equation (1).

$$\begin{matrix}[ Equation 1 ] & \\ {y}_{1} = {\sum }_{i = 1}^{N} {w}_{i} {x}_{i} & ( 1 )\end{matrix}$$

Thus, in a neural network, a large amount of the input data represented by floating point and the product-sum operation using the coefficient represented by floating point (hereinafter referred to as “floating point product-sum operation”) are executed, and the output data is calculated. The inference processing performs a large number of floating-point product sum operation, which requires a large amount of the memory to store the floating-point data. The data processing device 1 performs the cumulative addition of the coefficient based on the binarized input data instead of the floating-point product-sum operation. In other words, the data processing device 1 can perform the operation corresponding to the product-sum operation by the floating point by performing the cumulative addition of the coefficient based on the binarized input data.

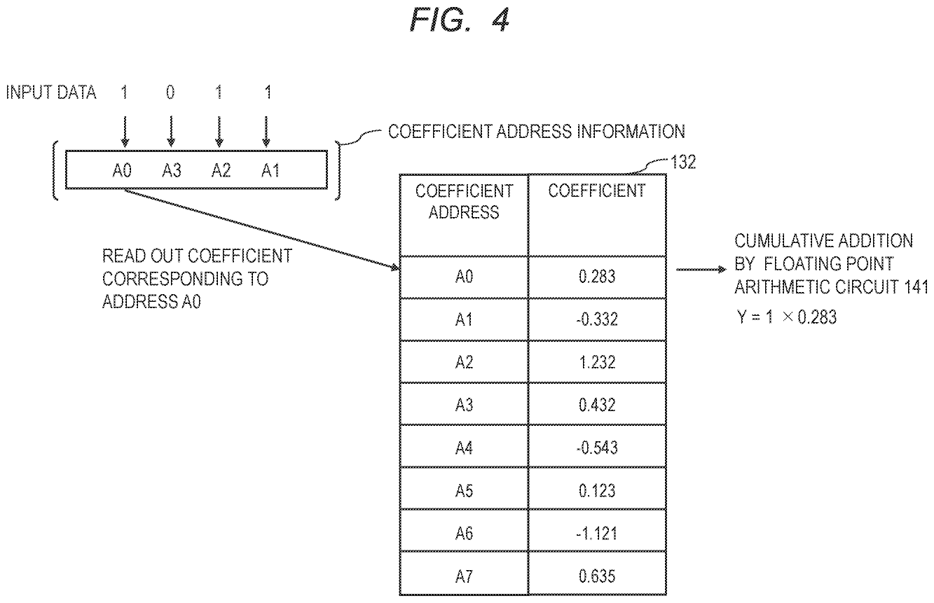

FIGS. 4 to 7 are diagrams showing conceptual of the product-sum operation required in a neural network in the data processing device according to first embodiment. FIGS. 4 to 7 show four binarized input data of (1 0 1 1) as an illustration of the binarized input data. In FIGS. 4 to 7, the coefficient addresses are A0 to A7. The coefficient address information, on the other hand, are represented by (A0 A3 A2 A1) in FIGS. 4 to 7. Of the coefficient addresses A0 to A7, the coefficient addresses used in the product-sum operation shown in FIGS. 4 to 7 are A0, A1, A2, and A3. The coefficient address information contains the coefficient addresses combinations corresponding to the coefficient used in the specific product-sum operation. In addition, the coefficient address information also contains information about the reading order of the coefficient address, corresponding to the calculation order of the coefficient in the product-sum operation. In other words, if the coefficient address information contains more than one coefficient addresses, the coefficient addresses included in the coefficient address information are arranged to be read in a predetermined order.

The coefficient address information will be described in more detail with reference to FIGS. 4 to 7, In FIGS. 4 to 7, the coefficient address A0 is the address that stores the coefficient to be multiplied by the leftmost one (first input data) of input data (1 0 1 1). The coefficient address A3 is an address that stores the coefficient multiplied by the second 0 (second input data) from the left end of input data (1 0 1 1). The coefficient. address A2 is the address that stores the coefficient to be multiplied by the third 1 (third input data) from the left end of the input data (1 0 1 1). The coefficient address A1 is an address that stores the coefficient to be multiplied by the fourth 1 (fourth input data) from the left end of the input data (1 0 1 1). The coefficient address information (A0 A3 A2 A1) is predetermined by models of neural networks as shown in FIG. The input data (1 0 1 1) and the coefficient address information (A0 A3 A2 A1) each have four elements. Hereinafter, an array of the coefficient address information, the coefficient address is regarded as a matrix, and is also referred to as a “coefficient address matrix”. For example, (A0 A3 A2 A1) a 1×4 coefficient address matrix. In FIGS. 4 to 7, 1×4 coefficient address matrices are shown as examples of the coefficient address matrices, but the number of components of coefficient address matrix is not limited to this number. The coefficient address matrix may be a 1×N matrix, where N is a natural number.

To the product-sum operation the four binarized input data and the coefficient, the inference controller 142 first reads 1 from the input output data storage unit 130, which is the leftmost binarized input data of (1 0 1 1), as shown in FIG. 4. The input data determination circuit 140 determines that the binarized input data read from the input output data storage unit 130 is a predetermined value of 1. The inference controller 142 reads the coefficient address A0 from the coefficient address information storage unit 131 based on the determination result of the input data determination circuit 140. Subsequently, the inference controller 142 reads out a coefficient 0.283 corresponding to the address A0 from the coefficient storage unit 132 based on the coefficient address A0. The inference controller 142 inputs the floating point arithmetic unit 141 to the coefficient 0.283 read from the coefficient storage unit 132 by the inference controller 142 is performed the cumulative addition by the floating point arithmetic circuit 141.

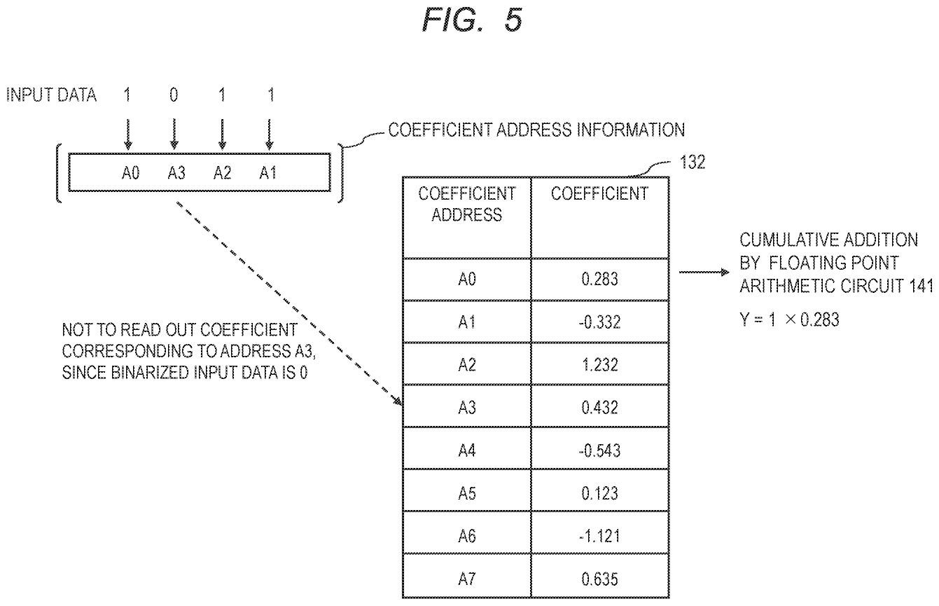

Next, as shown in FIG. 5, the inference controller 142 reads 0, which is the second leftmost binarized input data of (1 0 1 1) , from the input output data storage unit 130. The input data determination circuit 140 determines that the binarized input data is not a predetermined value of “1”. Therefore, the inference controller 142 controls not to read the coefficient address (A3) from the coefficient address information storage unit 131 based on the determination result of the input data determination circuit 140.

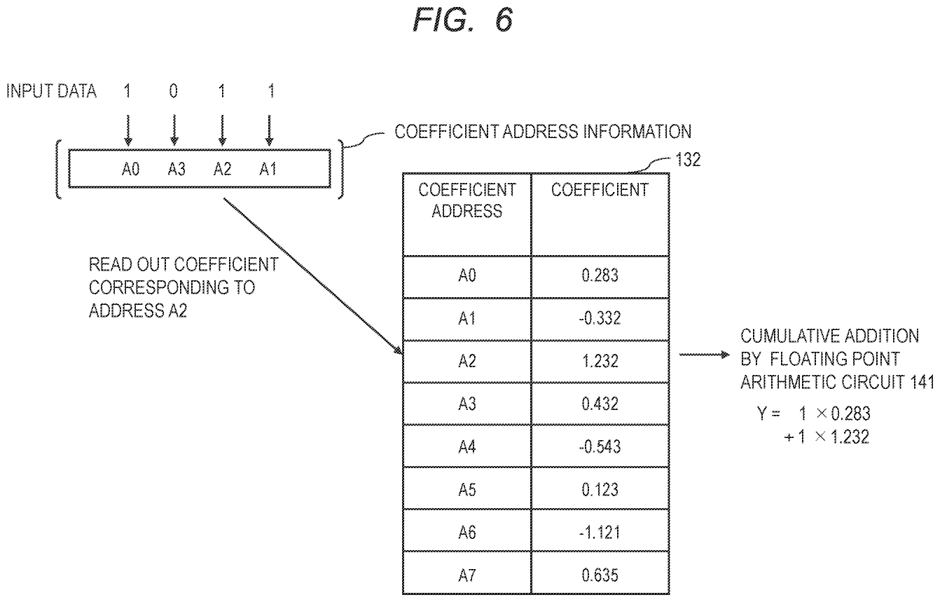

Subsequently, as shown in FIG. 6, the inference controller 142 reads 1, which is the third binarized input data from the left of (1 0 1 1), from the input output data storage unit 130. The input data determination circuit 140 determines that the binarized input data read from the input output data storage unit 130 is a predetermined value of 1. The inference controller 142 reads the coefficient address A2 from the coefficient address information storage unit 131 based on the determination result of the input data determination circuit 140. Subsequently, the inference controller 142 reads the coefficient 1.232 corresponding to the address A2 from the coefficient storage unit 132 based on the coefficient address A2. The inference controller 142 inputs the floating point arithmetic unit 141 to a coefficient 1.232 read from the coefficient storage unit 132 by the 142 is performed the cumulative addition by the floating point arithmetic circuit 141.

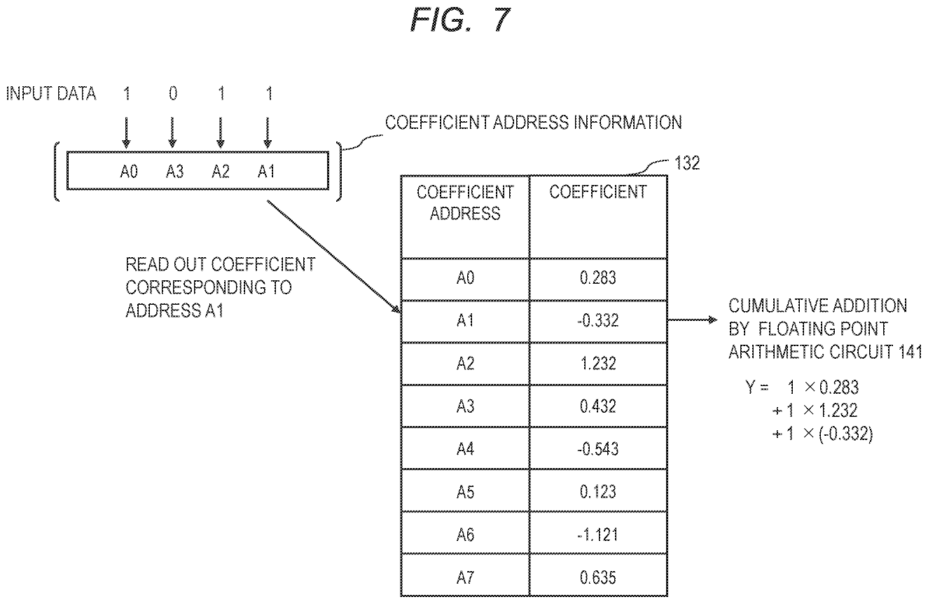

Finally, as shown in FIG. 7, the inference controller 142 reads 1, which is the fourth leftmost binarized input data of (1 0 1 1), from the input output data storage unit 130. The input data determination circuit 140 determines that the binarized input data read from the input output data storage unit 130 is a predetermined value of 1. The inference controller 142 reads the coefficient address A1 from the coefficient address information storage unit 131 based on the determination result of the input data determination circuit 140. Subsequently, the inference controller 142 reads the coefficient −0.332 corresponding to the address A1 from the coefficient storage unit 132 based on the coefficient address A1. The inference controller 142 inputs the floating point arithmetic circuit 141 the coefficient −0.332 read from the coefficient storage unit 132 by 142, is performed the cumulative addition at the floating point arithmetic circuit 141.

Thus, the cumulative addition of the binarized input data and coefficient according to the floating point arithmetic circuit 141 shown in FIGS. 4 to 7 replaces the product-sum operation of the floating point input data and float int weight parameters.

FIGS. 4-7 show the product-sum operation. for four binarized input data (1 0 1 1). In the neural network inference processing, the data processing device 1 sequentially reads the required number of the binarized input data from the input output data storage unit 130 and repeatedly executes the product-sum operation described above.

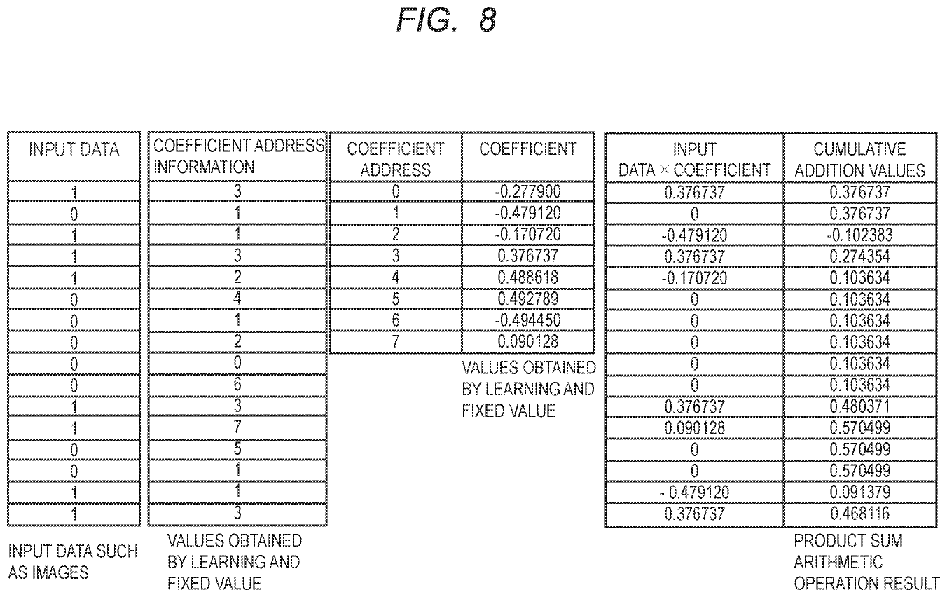

FIG. 8 is a diagram illustrating an exemplary product-sum operation process performed by the data processing device according to first embodiment. Referring to FIG. 8, the coefficient and the coefficient address information are values obtained by learning the neural network, and are a fixed value in the inference processing according to the data processing device 1. The input data is, for example, an input data such as images. if the input data determination circuit 140 determines that input data is not 1, which is a predetermined value, it does not acquire the coefficient address information, so that when the input data is 0, the result of multiplying input data) x(coefficient) is represented as 0. The cumulative addition values represent the course and results of the product-sum operation according to the floating point arithmetic circuit 141. In the product-sum operation shown in FIG. 8, a final product sum arithmetic operation result of 0.468116 is obtained.

### <Process Flow Details>

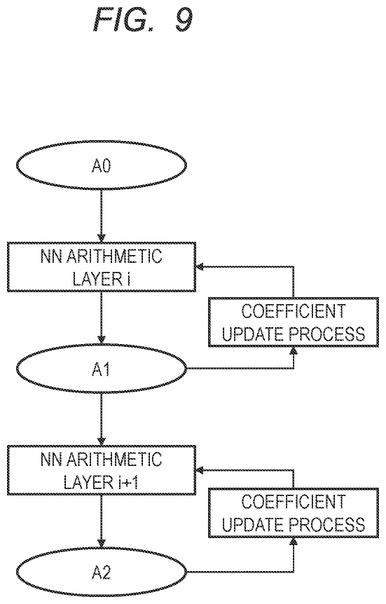

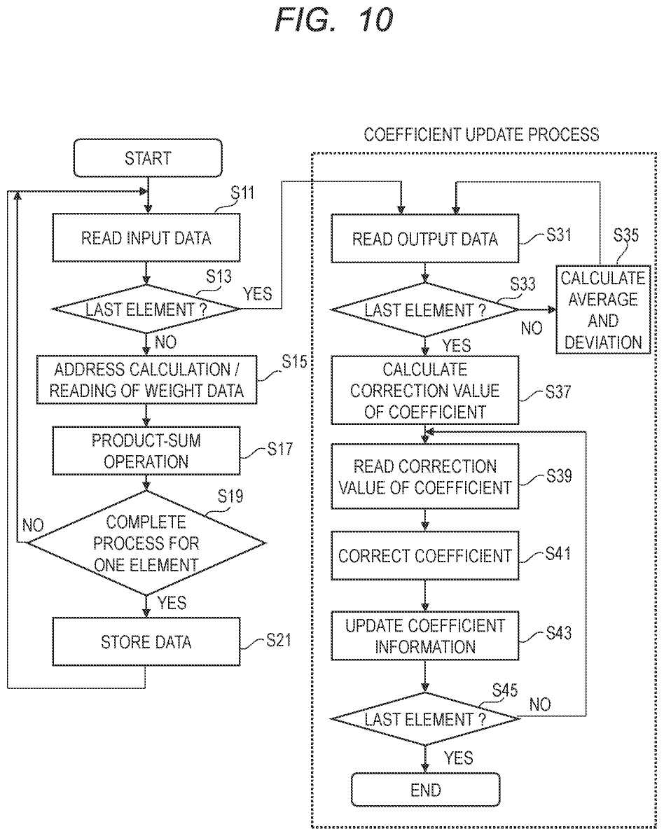

FIG. 9 is a diagram illustrating an outline of a process flow according to the first embodiment of the present invention. FIG. 10 is a flow chart illustrating a detailed process flow according to the first embodiment of the present invention. FIG. 9 shows the processing flow in the entire neural network. As shown in FIG. 9, in present embodiment, after the inference processing by the product-sum operation is performed in each layer (NN arithmetic layers i, i+1) of the neural network (steps A1, A2), a coefficient update process is performed as the learning process. Note that although only some layers are shown in FIG. 9, there are actually more layer.

On the other hand, FIG. 10 shows details of the processing flow in the entire neural network. In FIG. 10, the left side shows the flow of the product-sum operation process, and the right side shows the flow of the coefficient update process. In FIG. 10, the product-sum operation process includes steps S11 to S21, and the coefficient update process includes steps S31 to S45.

When the product-sum operation process is started, the inference controller 142 reads the binarized input data from the input output data storage unit 130 and transmits the binarized input data to the input data determination circuit 140 (in step S11).

In step S13, the inference controller 142 determines whether the input data read immediately before is a last element. If the last read input data is the last element (yes), the inference controller 142 notifies the learning controller 151 that it has read the last element, and the coefficient update process is performed in the learning processor 150. This notification includes, for example, various information such as the coefficient address corresponding to input data and the address of the input output data storage unit 130 in which the product sum arithmetic operation result is stored.

On the other hand, if the previously loaded input data is not the last element (NO) , the process in step S15 is performed. Next, upon receiving the binarized input data, the input data determination circuit 140 determines whether the binarized input data is a predetermined value (e.g., 1) step S15). Address calculation and reading of weight data is operated.

If the input data determination circuit 140 determines that the binarized input data is 0, the inference controller 142 does not read the coefficient address corresponding to this input data from the coefficient address information storage unit 131.

On the other hand, if the input data determination circuit 140 determines that the binarized input data is 1, the inference controller 142 refers to coefficient address information and obtains the coefficient address corresponding to this input data from the coefficient address information storage unit 131. Here, the coefficient address is information about the address where the coefficient is stored, and is integer data.

Subsequently, the inference controller 142 reads and accesses the coefficient storage unit 132 based on the coefficient address acquired from the coefficient address information storage unit 131, and acquires the coefficient. Where the coefficient is a floating-point number.

The inference controller 142 transmits the acquired coefficient to the floating point arithmetic circuit 141. When the coefficient is inputted, the floating point arithmetic circuit 141 performs the product-sum operation on the cumulative addition of the floating-point data, i.e., the data input data (in step S17). The cumulative addition of the coefficient by the floating point arithmetic circuit 141 replaces the multiplier and add operations for the floating point form of input data and the floating point form of the coefficient.

After the cumulative addition of the coefficient by the floating point arithmetic circuit 141 is performed, the inference controller 142 determines whether or not the process for the input data corresponding to an one element has been completed (in step S19). The step S19 may be performed by referring to the determination result in the step S13.

When the process for the one element minutes of the input data is completed, that when the input data is the final input data (YES), the process proceeds to step S21, and the product sum arithmetic operation result is stored in the input output data storage unit 130. Then, the process returns to step S11, and the product-sum operation process is performed on the input data corresponding to the following one element.

On the other hand, step S19, if the process for the input data for the one element has not been completed, that is, if the input data is not the final input data (NO), the process returns to step S11. The inference controller 142 then reads the next binarized input data in the same element from the input output data storage unit 130 and sends the next binarized input data to the input data determination circuit 140.

The inference processing is executed for each one element. The inference processor 14 repeatedly executes the inference processing by executing the product-sum operation for each one element in sequence.

### «Coefficient Update Process»

Next, the coefficient update process will be described. In FIG. 10, steps S31 to S45 are shown as the coefficient update process.

The learning controller 151 accesses the input output data storage unit 130 by referring to the address information notified from the inference controller 142, and reads the product sum arithmetic operation result (output data) of the one element stored in input output data storage unit 130 (in step S31). The learning controller 151 transmits the read the output data to the output distribution calculate circuit 153.

Next, in step S33, the learning controller 151 determines whether or not output data read immediately before is the output data of the last element. If the previously read output data is not the output data of the last element (NO), step S35 is executed.

The output distribution calculate circuit 153 analyzes the product sum arithmetic operation result transmitted from the learning controller 151, calculates the analysis result (e.g., average, deviation, etc.) (in step S35). Specifically, the output distribution calculate circuit 153 performs analysis using all the product-sum arithmetic operation result read after the beginning of this coefficient update process, and calculates the analysis result.

On the other hand, in step S33, if the output data read immediately before is output data of the last element (YES), the process proceeds to step S37. In step S37, the output. distribution calculate circuit 153 calculates the correction value of the coefficient related to all output data based on the analysis result in step S35. The correction value of coefficient calculated here is, for example, the correction value for all analysis result used to calculate the product-sum operation, but only correction value for some coefficient may be calculated.

The output distribution calculate circuit 153 transmits the calculated coefficient of the correction value to the learning controller 151.

The learning controller 151 reads correction value of the coefficient calculated in the output distribution calculate circuit 153, for example, the correction value every one element is read from the output distribution calculate circuit 153 (in step S39). In addition, the learning controller 151 reads coefficient to be corrected from the coefficient storage unit 132 based on the coefficient address transmitted from the inference controller 142. Then, the learning controller 151 transmits the correction value of coefficient read from the output distribution calculate circuit 153 and coefficient read from the coefficient storage unit 132 to the coefficient updating circuit 155.

In step S41, the coefficient updating circuit 155 updates the coefficient by overwriting the coefficient read from the coefficient storage unit 132 with the correction value of coefficient calculated by the output distribution calculate circuit 153. That is, the coefficient is corrected in step S41. The coefficient updating circuit 155 transmits the updated coefficient to the learning controller 151.

In step S43, the learning controller 151 transmits the coefficient updated by the coefficient updating circuit 155 to the coefficient storage unit 132 and overwrites it, thereby updating information of the coefficient stored by the coefficient storage unit 132.

In step S45, the learning controller 151 determines whether the coefficient updating process for the last element has been completed, If the coefficient update process for the last element has not been completed (NO), the process returns to step S39, and the coefficient update process for the following element is executed. On the other hand, when the coefficient updating process for the last element is completed (YES), the coefficient update process terminates.

The coefficient update process is performed before the next input data is supplied. The coefficient stored in the coefficient storage unit 132 is preferably updated before the inference processing of the next input data is started, but the coefficient update process based on the previous inference processing maybe performed when the next input data is supplied. In this instance, the inference processing for the present input data and the coefficient update process based on the inference result (output data) for the immediately preceding input. data are performed in parallel.

<Main Effects of the Present Embodiment>

According to present embodiment, the learning process are performed by analyzing the output result and updating coefficient with the correction value. This configuration reduces the burden on learning process and facilitates the learning process at the endpoint. As a result, since the models can be updated by learning the immediately preceding inference processing, the deterioration of the recognition accuracy can be suppressed in all circumstances.

### Second Embodiment

Next, second embodiment will be described. Present embodiment is similar to first embodiment, but differs from first embodiment in that the coefficient update process based on the immediately preceding input data is performed, followed by the inference processing to the following input data.

For example, in inference processing for the moving image, after the coefficient update process based on inference processing for the image data (input data) of the n-th frame is performed, the inference processing for the image data of the (n+1)-th frame is performed.

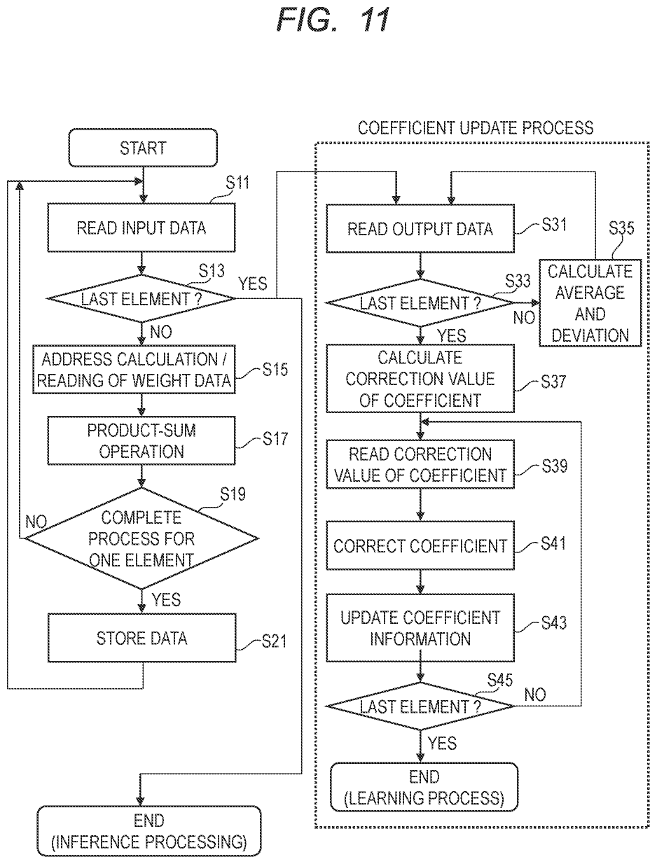

FIG. 11 is a flowchart illustrating a detailed process flow according to the first embodiment of the present invention. FIG. 11 is similar to FIG. 10, and when the input data read immediately before is the last element (Yes) in step S13, the inference controller 142 notifies the learning controller 151 that the last element has been read, and terminates the inference processing. The other processes are the same as those of first embodiment. Then, the inference processing is restarted after the coefficient update process is completed.

The inference processing for the n-th frame in the subsequent layer may be performed prior to the completion of the coefficient update process.

According to present embodiment, the inference processing can be executed by using the coefficient updated by reflecting the analysis result of the immediately preceding input data.

When the inference processing and the coefficient update processes can be performed by hardware, the coefficient update process can be performed without delay. This allows the inference processing to the following input data using the updated coefficient, while allowing the same process as first embodiment.

### Third Embodiment

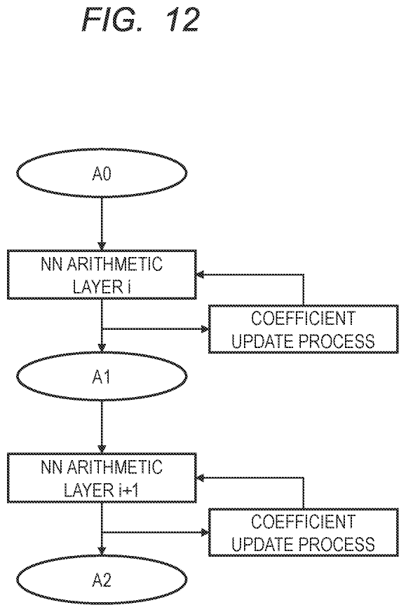

Next, third embodiment will he described. In present embodiment, the output data (product-sum operation process) is analyzed for each one element. FIG. 12 is a diagram illustrating an outline of a process flow according to third embodiment of the present invention, As shown in FIG. 12, in present embodiment, the inference processing and the coefficient update processes for the same input data are performed in parallel.

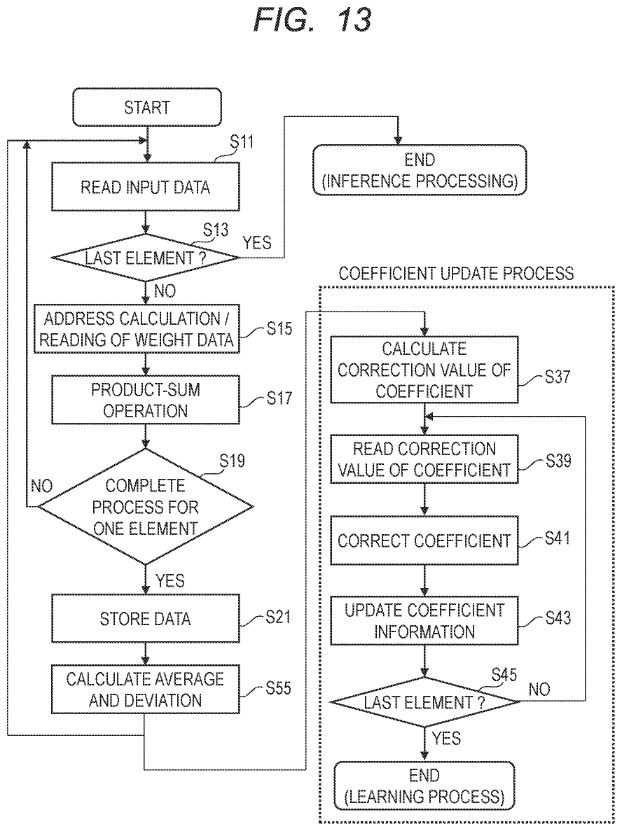

FIG. 13 is a flowchart illustrating a detailed process flow according to the third embodiment of the present invention. FIG. 13 is similar to FIG. 11, in which step S55 is added after step S21, and steps S31 to S35 are deleted.

When the product-sum operation process for the one element is completed in step S21, the process proceeds to step S55. In step S55, the learning controller 151 reads out the product sum arithmetic operation result stored in the immediately preceding step S21, and transmits it to the output distribution calculate circuit 153, The output distribution calculate circuit 153 performs an analysis on the learning controller 151 read the one element the product sum arithmetic operation result (output data) to calculate the analysis result of the one element minute. The calculated one element amount of the analysis result may be held in the output distribution calculate circuit 153 or may be stored in the memory outside the output distribution calculate circuit 153. In step S55, the analysis result (e.g., average, deviation, etc.) are calculated.

When the process of step S55 is completed, the process returns to step S11, and the inference processing for the following element is performed. Further, when the process of step S55 is completed, the analysis result is transferred to step S37, and the coefficient update process based on the transferred analysis result is executed simultaneously with the inference processing. The processes in step S37 and subsequent steps in present embodiment are substantially the same as those in steps first embodiment and second embodiment.

Further, in the second and subsequent step S55, the output distribution calculate circuit 153, the product-sum arithmetic operation result of this time, by performing an analysis using the product-sum arithmetic operation result up to the previous time, to calculate the analysis result using all the product-sum arithmetic operation result. Although the analysis may be performed using only a part of the product sum arithmetic operation result, for example, when the deviation is calculated, it is preferable to use average values using all the product sum arithmetic operation result.

In step S13, if input data read immediately before is the last element (Yes) , the inference controller 142 notifies the learning controller 151 that the last element has been read, and terminates the inference processing.

According to present embodiment, in the analysis of output data (product sum arithmetic operation result), the analysis for the output data is performed for each one element prior to all output data being issued. This reduces the number of accesses to the output data during the coefficient update process, and improves the coefficient update process.

### Fourth Embodiment

Next, fourth embodiment will be described. Coefficient at the time of quantize the floating-point input data (hereinafter also referred to as quantization coefficient) is generally changed dynamically based on, for example, the largest and smallest values in input data distributions.

However, in order to perform such a process, it is required to read out all input data, extract the largest value and the smallest value, and quantize all input data based on these values by a division process or the like. Thus, it is difficult to implement such a function because of its slow execution.

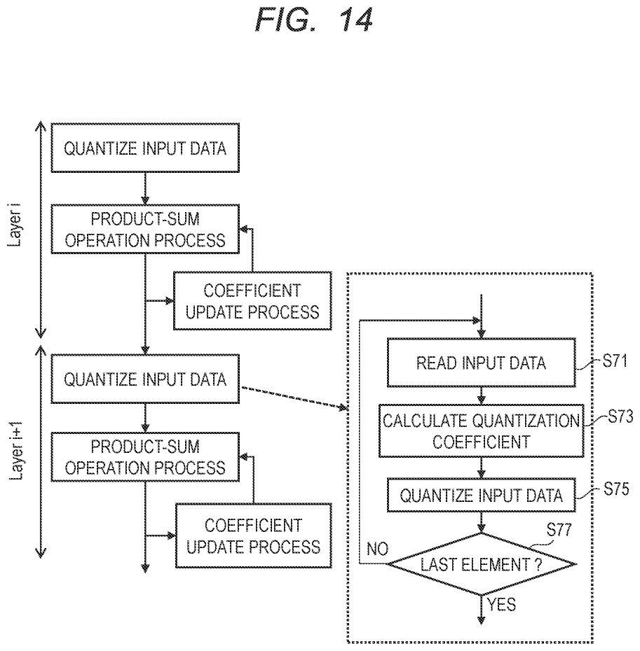

FIG. 14 is a diagram illustrating a process flow according to fourth embodiment of the present invention. FIG. 14 shows an outline of the process flow and a detailed flow related to quantization of the input data. This section focuses on the layer i+1 in FIG. 14 and describes how quantize the input data.

Here, the inference processor 14 will be described as performing the quantization of the input data, may be performed in the learning processor 150.

First, in step S71, the input data is read. Prior to this, in present embodiment, the output data of the input data, i.e., the layer i, prior to quantization is stored in the memory such as the input output data storage unit 130. The inference controller 142 accesses predetermined addresses of the input output data storage unit 130, for example, and reads output data of the layer i.

Next, in step S73, the inference controller 142 calculates the quantization coefficient based on the read input data. The quantization coefficient is calculated for each one element. Specifically, the inference controller 142 monitors the output data of the layer i and adjusts the quantization coefficient so that output data of the layer i distribution falls within a predetermined range. The inference controller 142 may internally hold the adjusted the quantization coefficient or may store it in the memory.

Next, in step S75, the quantization unit (not shown) performs quantization of the input data based on the adjusted quantization coefficient, the inference controller 142 stores the quantized input data in the quantization unit in the input output data storage unit 130.

Next, in step S77, it is determined whether or not the quantization of the input data corresponding to the last element has been performed. If it is determined that the quantization of the input data corresponding to the last element has not yet been performed (NO), the process returns to step S71 and the quantization of the input data corresponding to the following element is performed.

On the other hand, if it is determined in step S77 that the quantization of input data corresponding to the last element. has been performed (YES), the quantization process of the input data is completed, and the inference processing by the product-sum operation is executed.

According to present embodiment, while monitoring the output data of layer immediately before the neural network, adjust the quantization coefficient so that the output data distribution. falls within a certain range. According to this configuration, there is no need to extract the maximum value and minima at the input data corresponding to all element, and the burden associated with adjusting the quantization coefficient is reduced.

### Fifth Embodiment

Next, fifth embodiment will he described. Normally, when the output data of float (decimal point) for the one element is obtained by the product-sum operation in the layer i, the output data is saved as float until product-sum operation processing for all element is completed. For this reason, the output data needs to temporarily store the intermediate data in float format in the memory until the intermediate data is quantized to the input data of the layer i+1, and consumes a lot of the memory resources.

On the other hand, the quantization coefficient can be fixed if fourth embodiment's method is used and the quantization coefficient can he adjusted appropriately. If the quantization coefficient fixed, it is possible to immediately quantize float output of the one element obtained in the layer i. Present embodiment uses this technique to reduce memory resources.

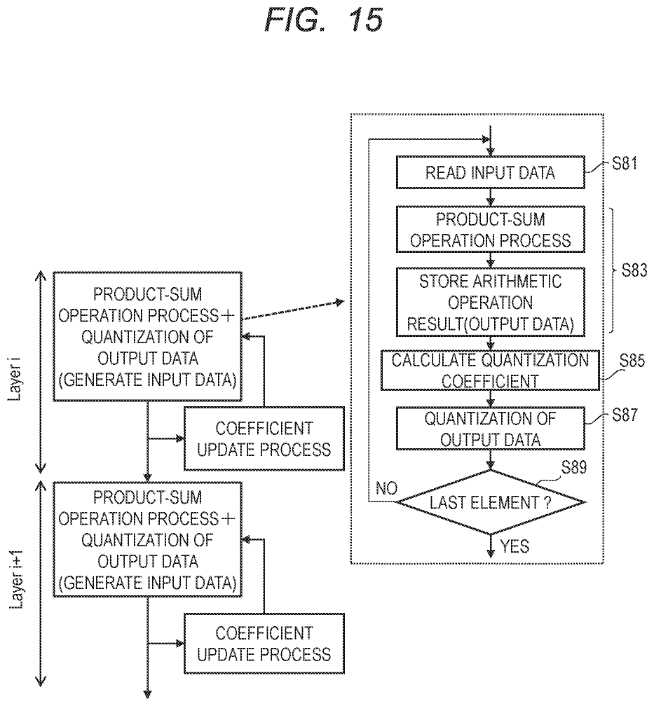

FIG. 15 is a diagram illustrating a process flow according to fifth embodiment of the present invention. FIG. 15 shows an outline of the processing flow and a detailed flow related to the quantization and the product-sum operation processing of the input data. Here, an explanation will be given focusing on the layer i.

As shown in FIG. 15, in present embodiment, quantization is performed on the output data in the layer i, and the following input data of the layer i+1 is generated. That is, in the above embodiment, quantization is performed in the layer where the estimation process is performed, and the input data is generated. On the other hand, in present embodiment, the input data is generated in the layer immediately before layer in which the estimation process is performed.

In step S81, the input data is read. This input data was generated by the previous a layer i−1. The inference controller 142 accesses predetermined addresses of the input output data storage unit 130, for example, and reads output data of the layer i−1.

Next, in step S83, the product-sum operation process and the arithmetic operation result are stored. These processes correspond to steps S15 to S21 in FIG. 10, for example. The output data (floating-point data) for the layer i are generated in step S83.

Next, in step S85, the inference controller 142 reads out the quantization coefficient. As described above, the quantization coefficient is fixed in present embodiment. And it calculates the quantization coefficient.

Next, in step S87, the quantization unit (not shown) performs quantization of the output data based on the quantization coefficient, and generates the input data of the following layer i+1. The inference controller 142 stores the generated input data in the input output data storage unit 130. In step S89, it is determined whether or not quantization of the output. data corresponding to the last element has been performed. If it is determined that the quantization of the output data corresponding to the last element has not yet been performed (NO), the process returns to step S81, where the input data corresponding to the following element is read out, the inference processing is performed on the input data, and the output data is generated.

On the other hand, if it is determined in step S89 that the quantization of the input data corresponding to the last element has been performed (Yes), the quantization process of the output data ends. Then, the layer i+1 is populated with the input data generated by the layer i.

According to present embodiment, the quantization process is performed on the output data generated for each one element by the same layer, and the input data for the following layer is generated. With this configuration, it is not necessary to store all output data of 1 layer in float format, and the memory resources can be reduced.

Although the invention made by the present inventor has been specifically described based on the embodiment, the present invention is not limited to the embodiment described above, and it is needless so say that various modifications can be made without departing from the gist thereof.

What is claimed is:

1. A data processing device comprising:
an inference processor; and
a learning processor,
wherein the inference processor comprising:
an input data determination circuit determined to determine whether or not it is a predetermined value for each of binarized input data;
a memory storing a plurality of coefficients and a coefficient address information including information about the coefficient address in which the plurality of coefficient;
an inference controller reading the coefficient address from the memory on the basis of a determination result of the input data determination circuit and reading the coefficient from the memory on the basis of the coefficient address; and
an arithmetic circuit that performs an operation using the binarized input data and the coefficient acquired by the inference controller to generate the arithmetic operation result as an output data,
wherein the learning processor comprising:
an output distribution calculate circuit analyzing the output data and calculating a correction value of the coefficient based on the analysis result;
a coefficient updating circuit updating the coefficient stored in the memory with the correction value of the coefficient calculated by the output distribution calculate circuit; and
a learning processor for controlling the updating of the coefficient,

2. The data processing device according to claim 1,
wherein the output distribution calculate circuit performs analysis using the plurality of output data corresponding to each of a plurality of element.

3. The data processing device according to claim 1,
wherein the analysis result includes an average and a deviation.

4. The data processing device according to claim 1,
wherein in case of the inference processor performs an operation using the binarized input data corresponding to the last element, the inference processing is terminated.

5. The data processing device according to claim 1,
wherein the arithmetic circuit performs an operation using the binarized input data corresponding to a one element,
wherein the output distribution calculate circuit analyzes the output data corresponding to the one element,
wherein the arithmetic circuit performs an operation using the binarized input data corresponding to the second or subsequent one element, and
wherein the output distribution calculate circuit performs analysis using the output data and output data up to the previous time, performs analysis using all output data, and calculates the correction value of the coefficient based on the analysis result using all output data.

6. The data processing device according to claim 1,
wherein the inference processor adjusts a quantization coefficient used in quantize of input data prior to being binarized.

7. The data processing device according to claim 6,
wherein the inference processor monitors a previous layer's output data and adjusts the quantization coefficient so that the previous layer's output data distribution falls within a predetermined range.

8. The data processing device according to claim 1,
wherein the inference processor performs an operation using the binarized input data to generate the output data, quantities the output data, and generates input data of the following layer.

9. A method of data processing, comprising the steps of:
(a) storing a plurality of coefficients and coefficient address information including information about the coefficient address in which the plurality of coefficients is stored in a memory;
(b) determining whether or not an input data determination circuit is a predetermined value for each of binarized input data;
(c) performing an operation using the binarized input data and the coefficient, and generating an arithmetic operation result as output data by an arithmetic circuit;
(d) analyzing the output data and calculating a correction value of the coefficient based on the analysis result, by the output distribution calculate circuit; and
(e) updating the coefficient stored in the memory with the correction value of the coefficient calculated by the output distribution calculate circuit, by the coefficient updating circuit.

10. Recording media storing a data processing program:
wherein the data processing program comprising the steps of:
(a) storing a plurality of coefficients and coefficient address information including information about the coefficient address in which the plurality of coefficients is stored in a memory;
(b) determining whether or not an input data determination circuit is a predetermined value for each of binarized input data;
(c) performing an operation using the binarized input data and the coefficient acquired by an inference controller, and generating an arithmetic operation result as output data by an arithmetic circuit;
(d) analyzing the output data and calculating a correction value of the coefficient based on the analysis result, by the output distribution calculate circuit; and
(e) updating the coefficient stored in the memory with the correction value of the coefficient calculated by the output distribution calculate circuit, by the coefficient updating circuit.
